(19) United States
(12) Patent Application Publication
(10) Pub. No.: US 2012/0229386 A1
(43) Pub. Date: Sep. 13, 2012

(54) RETRACTABLE CABLE MOUSE

(75) Inventors: A-Ming Chang, Taipei (TW); Ying-Che Tseng, Taipei (TW)

(73) Assignee: PRIMAX ELECTRONICS LTD., Taipei (TW)

(21) Appl. No.: 13/105,729

(22) Filed: May 11, 2011

(30) Foreign Application Priority Data
Mar. 11, 2011 (TW) 100108269

(51) Int. Cl. G06F 3/033; H02G 11/02; B65H 75/48

(52) U.S. Cl. 345/163; 191/12.2 R

(57) ABSTRACT

A retractable cable mouse includes a casing, a cable reel member, a connector and a sliding member. The connector is coupled with the cable reel member and in contact with the sliding member. When the sliding member is moved to a first position, the connector is accommodated within the casing. When the sliding member is moved to a second position, the connector is pushed by the sliding member to be exposed outside the casing. At the same time, a perforation of the casing is blocked by sliding member, so that the external dust or foreign material fails to be introduced into the internal portion of the casing.

### FIELD OF THE INVENTION

The present invention relates to a mouse, and more particularly to a retractable cable mouse.

### BACKGROUND OF THE INVENTION

Hereinafter, the configurations and the function of a conventional wheel mouse will be illustrated with reference to FIG. 1. FIG. 1 schematically illustrates the connection between a conventional mouse and a computer system. As shown in FIG. 1, the computer system 2 comprises a computer host 21 and a computer monitor 22. The computer host 21 is in communication with a wheel mouse 1 and the computer monitor 22. The computer host 21 has a connecting port 211. A graphic-based window 221 and a cursor 222 are shown on the computer monitor 22. The wheel mouse 1 is used for controlling the cursor 222 to have the computer host 21 execute a corresponding command. The wheel mouse 1 comprises a casing 10, a left button 11, a right button 12, a scroll wheel 13, a connecting cable 14 and a connector 15. The casing 10 is used for supporting a user's palm. When the casing 10 is moved by the user to result in a displacement amount, the computer host 21 correspondingly moves the cursor 222 shown on the computer monitor 22 according to the displacement amount. By clicking the left button 11 or the right button 12, a control signal is issued to the computer host 21. In response to the control signal, the computer host 21 executes a corresponding command. The scroll wheel 13 is arranged between the left button 11 and the right button 12. By rotating the scroll wheel 13, a scrolling signal is generated. In response to the scrolling signal, the computer host 21 executes a function of scrolling the graphic-based window 221. An end of the connecting cable 14 is connected with the connector 15. Through the connecting cable 14, these signals may be transmitted to the computer host 21. After the connector 15 is plugged into the connecting port 211 of the computer host 21, the communication between the wheel mouse 1 and the computer host 21 will be established. The basic functions of the wheel mouse 1 have been mentioned above.

Generally, the conventional wheel mouse 1 has no mechanism for storing the connecting cable 14. Since the connecting cable 14 fails to be stored within the casing 10, if the user wants to carry the conventional wheel mouse 1, two approaches are employed to fix the connecting cable 14. In accordance with a first approach, the connecting cable 14 is bent for several turns to shorten the length thereof, and then the connecting cable 14 is bound together. In accordance with a second approach, the connecting cable 14 is wound around the casing 10. The connecting cable 14 fixed by these two approaches is neither convenient nor aesthetically pleasing. For solving the above drawbacks, a retractable cable mouse for concealing and storing the connecting cable has been introduced into the market.

Hereinafter, the configurations of a conventional retractable cable mouse will be illustrated with reference to FIG. 2. FIG. 2 is a schematic perspective view illustrating a conventional retractable cable mouse. As shown in FIG. 2, the retractable cable mouse 3 comprises a casing 30, an upper cover 31, a left button 32, a right button 33, a scroll wheel 34, a cable reel member 35 and a connector 36. The casing 30 has a perforation 301. The perforation 301 is formed at a front side of the casing 30. The casing 30 is sheltered by the upper cover 31. The upper cover 31 has an upper cover opening 311. The left button 32 and the right button 33 are disposed on the upper cover 31. The left button 32 is arranged at a first side of the upper cover opening 311. The right button 33 is arranged at a second side of the upper cover opening 311. The scroll wheel 34 is disposed within the casing 30. Moreover, the scroll wheel 34 is partially penetrated through the upper cover opening 311 and exposed outside the upper casing 31 to be manipulated by the user.

The cable reel member 35 comprises a connecting cable 351 and a reel main body 352. A first end of the connecting cable 351 is connected with the connector 36. A second end of the connecting cable 351 is connected with the reel main body 352. The reel main body 352 is used for winding the connecting cable 351 so as to store the connecting cable 351. As shown in FIG. 2, the connecting cable 351 is penetrated through the perforation 301 of the casing 30 and thus protruded outside the casing 30. The connector 36 is connected with the connecting cable 351 of the cable reel member 35. By connecting the connector 36 with the computer host 21 of the computer system 2 (see FIG. 1), the retractable cable mouse 3 is in communication with the computer host 21. In this embodiment, the connector 36 is a universal series bus (USB) connector.

FIG. 3 schematically illustrates the conventional retractable cable mouse whose connector is stored. In FIG. 3, a bottom surface 302 of the casing 30 of the retractable cable mouse 3 is shown. The bottom surface 302 has a receiving recess 3021. The receiving recess 3021 is disposed beside the perforation 301. The shape of the receiving recess 3021 is fitted to the shape of the connector 36. In a case that the retractable cable mouse 3 is in a non-usage status, the connecting cable 351 may be stored within the reel main body 352 but the portion of the connecting cable 351 coupled with the connector 36 is still exposed outside the casing 30. After the exposed portion of the connecting cable 351 is bent, the connector 36 coupled with the connecting cable 351 may be stored within the receiving recess 3021 (see FIG. 3).

From the above discussions, it is found that the connector 36 may be connected with the computer host 21 when the retractable cable mouse 3 is in the usage status. Moreover, when the retractable cable mouse 3 is in the non-usage status, the connecting cable 351 can be shortened and the connector 36 can be stored within the receiving recess 3021 by means of the cable reel member 35. Since the connecting cable 351 can be stored within the casing 30, the retractable cable mouse 3 is easily carried. Moreover, since the connecting cable 351 is not exposed outside the casing 30 in the non-usage status, the retractable cable mouse 3 is aesthetically pleasing. Although the conventional retractable cable mouse 3 has the above advantages, there are still some drawbacks. Since the connector 36 should be stored within the receiving recess 3021, if the retractable cable mouse 3 has been used for a long time, the portion of the connecting cable 351 coupled with the connector 36 is frequently bent and easily damaged. Under this circumstance, the signal fails to be transmitted to the computer host 21 through the connecting cable 351. For protecting the connecting cable 351, the connector 36 may be exposed outside the casing 30 without storing the connector 36 within the receiving recess 3021. However, if the retractable cable mouse 3 has been used for a long time, the connector 36 is also easily damaged.

### SUMMARY OF THE INVENTION

The present invention provides a retractable cable mouse having a mechanism for protecting the connector and the connecting cable.

In accordance with an aspect of the present invention, there is provided a retractable cable mouse. The retractable cable mouse includes a casing, a cable reel member, a connector and a sliding member. The casing has a sliding groove, which is disposed at a lower portion of the casing. The sliding groove has a first perforation and a second perforation. The first perforation is arranged at an end of the casing. The second perforation is arranged at a bottom surface of the casing. The cable reel member is disposed within the casing. The connector is coupled with the cable reel member, and selectively accommodated within the sliding groove or protruded outside the sliding groove. When the connector is protruded outside the sliding groove, the connector is permitted to be connected with a computer system. The sliding member is disposed within the sliding groove and arranged adjacent to the connector, and having an operating part. The operating part is protruded outside the second perforation and movable to allow the sliding member to be slid along the sliding groove. When the operating part is moved to a first end of the second perforation, the sliding member is slid to a first position of the sliding groove, so that the connector is stored within the sliding groove. When the operating part is moved to a second end of the second perforation, the sliding member is slid to a second position of the sliding groove to push the connector to allow the connector to be escaped from the sliding groove, and the first perforation is blocked by a front end of the sliding member, so that the able reel member is in a releasing status.

In an embodiment, the cable reel member includes a connecting cable and a reel main body. The connecting cable is penetrated through the sliding member to be coupled with the connected. The reel main body is used for storing the connecting cable. When the cable reel member is in the releasing status, the connecting cable is protruded out of the reel main body and exposed outside the casing. When the cable reel member is in the storing status, the connecting cable is stored within the reel main body in response to a pulling force generated by the reel main body.

In an embodiment, the retractable cable mouse further includes a pressing member, which is disposed over the sliding groove to stop the connecting cable from being escaped from the sliding member.

In an embodiment, the casing further includes a casing sidewall, a sliding groove sidewall, a first rib and a second rib. The casing sidewall is arranged at a side of the casing. The sliding groove sidewall is arranged at a side of the sliding groove and adjacent to the casing sidewall. The first rib is disposed on the sliding groove sidewall and adjacent to the first perforation of the sliding groove. The second rib is disposed on the sliding groove sidewall and arranged at a side of the first rib.

In an embodiment, the sliding member further includes a protrusion part, which is disposed on a surface of the sliding member. When the protrusion part is in contact with the first rib or the second rib, the sliding member is fixed on the first position or the second position of the sliding groove.

In an embodiment, the retractable cable mouse further includes a magnetic element. The magnetic element is arranged between the casing sidewall and the sliding groove sidewall for providing a magnetic force.

In an embodiment, the sliding member further includes a first metal part and a second metal part. The first metal part is disposed on a surface of the sliding member and arranged at a rear end of the sliding member. When the first metal part is magnetically attracted by the magnetic element, the sliding member is fixed at a second position of the sliding groove. The second metal part is disposed on the surface of the sliding member and arranged at a middle region of the sliding member. When the second metal part is magnetically attracted by the magnetic element, the sliding member is fixed at a first position of the sliding groove.

In an embodiment, the retractable cable mouse further includes an auxiliary roller. The auxiliary roller is in contact with a connecting cable of the cable reel member for facilitating the connecting cable to be pulled out or stored, wherein the casing further comprises a post, which is arranged between the sliding groove and the cable reel member, wherein the auxiliary roller is sheathed around the post, so that the auxiliary roller is fixed on the casing.

In an embodiment, the retractable cable mouse further includes an upper cover, a scroll wheel, a circuit board, an encoder, a displacement sensing element and plural triggering switches. The upper cover is used for sheltering the casing, wherein the upper cover has an upper cover opening. The scroll wheel is disposed on a scroll wheel seat of the casing and partially penetrated through the upper cover opening to be exposed outside the upper casing. A scroll wheel shaft is penetrated through the scroll wheel. The circuit board is disposed on the lower portion of the casing. The encoder is disposed on the circuit board and arranged at a side of the scroll wheel. A terminal of the scroll wheel shaft is inserted into the encoder. The encoder generates a scrolling signal in response to rotation of the scroll wheel. The displacement sensing element is disposed on the circuit board for detecting movement of the casing, thereby generating a motion signal. The triggering switches are disposed on the circuit board. When the triggering switches are triggered, corresponding signals are generated.

In an embodiment, the connector is a universal series bus (USB) connector.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a conventional mouse and a computer system;

FIG. 2 is a schematic perspective view illustrating a conventional retractable cable mouse;

FIG. 3 schematically illustrates the conventional retractable cable mouse whose connector is stored;

FIG. 4 is a schematic exploded view illustrating a retractable cable mouse according to an embodiment of the present invention;

FIG. 5 is a schematic perspective view illustrating the casing of the retractable cable mouse according to the embodiment of the present invention;

FIG. 6 is a schematic perspective view illustrating the internal portion of the retractable cable mouse according to the embodiment of the present invention;

FIG. 7 is a schematic assembled view illustrating the outward appearance of the retractable cable mouse according to the embodiment of the present invention;

FIG. 8 is a schematic rear view of the retractable cable mouse according to the embodiment of the present invention, wherein the connector is pulled out;

FIG. 9 is a schematic cutaway view of the retractable cable mouse according to the embodiment of the present invention, wherein the connector is pulled out;

FIG. 10 is a schematic rear view of the retractable cable mouse according to the embodiment of the present invention, wherein the connector is stored; and

FIG. 11 is a schematic cutaway view of the retractable cable mouse according to the embodiment of the present invention, wherein the connector is stored.

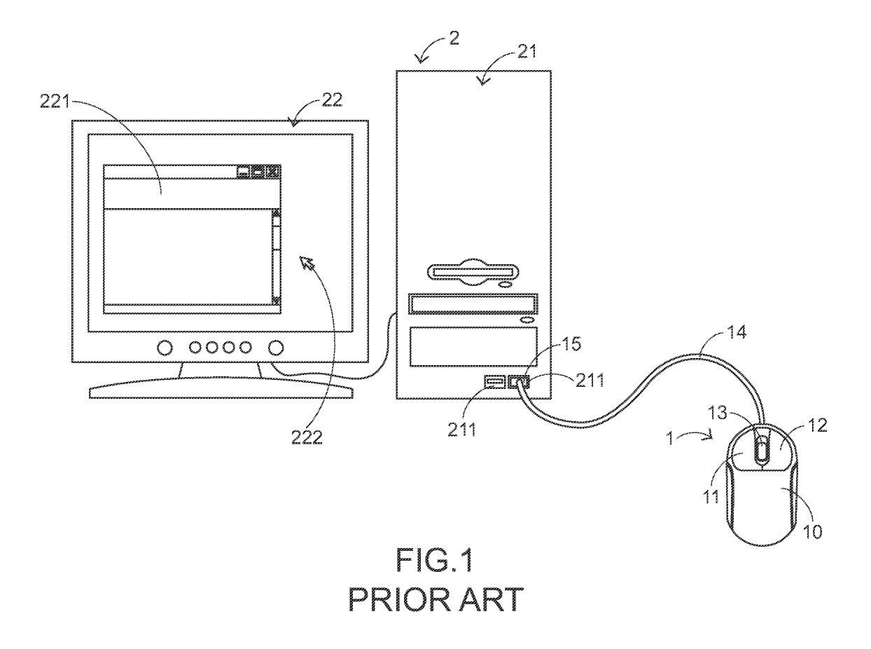

### DETAILED DESCRIPTION OF THE PREFERRED EMBODIMENT

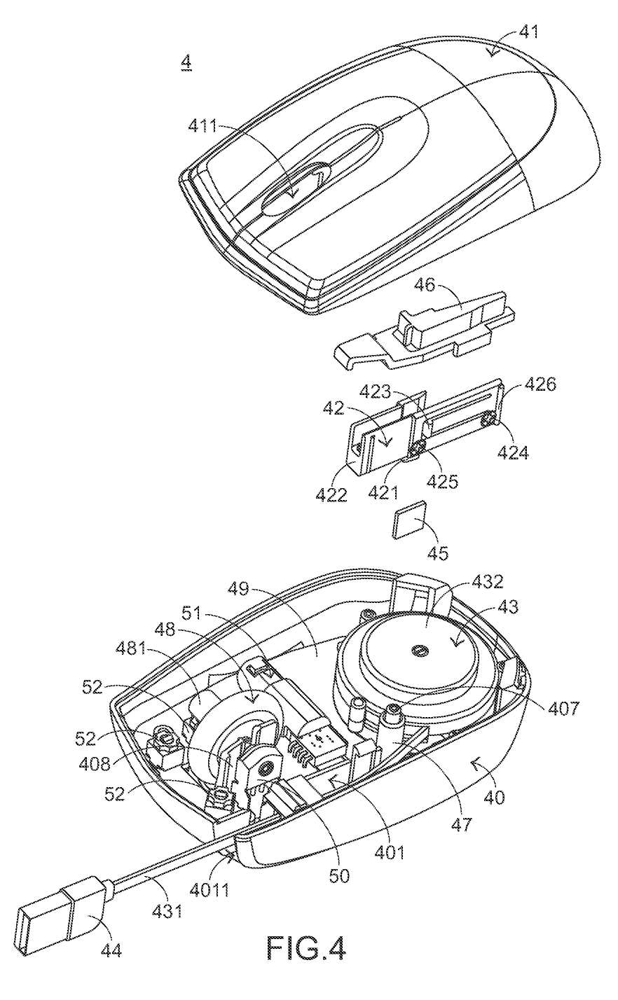

FIG. 4 is a schematic exploded view illustrating a retractable cable mouse according to an embodiment of the present invention. FIG. 5 is a schematic perspective view illustrating the casing of the retractable cable mouse according to the embodiment of the present invention. As shown in FIGS. 4 and 5, the retractable cable mouse 4 comprises a casing 40, an upper cover 41, a sliding member 42, a cable reel member 43, a connector 44, a magnetic element 45, a pressing member 46, an auxiliary roller 47, a scroll wheel 48, a circuit board 49, an encoder 50, a displacement sensing element 51 and a plurality of triggering switches 52.

Please refer to FIG. 4 again. The upper cover 41 has an upper cover opening 411. The sliding member 42 comprises an operating part 421, a protrusion part 423, a first metal part 424 and a second metal part 425. The protrusion part 423 is disposed on a surface of the sliding member 42. The first metal part 424 disposed on the surface of the sliding member 42 and arranged at a rear end 426 of the sliding member 42. The second metal part 425 disposed on the surface of the sliding member 42 and arranged at a middle region of the sliding member 42. In this embodiment, the first metal part 424 and the second metal part 425 are metallic screws that are tightened in the sliding member 42. The sliding member 42 is substantially has an elongated U-shaped structure. Moreover, the operating part 421 is integrally formed on the sliding member 42. In some embodiments, the first metal part 424 and the second metal part 425 are metal sheets or metal blocks that are fixed on the sliding member 42.

Please refer to FIG. 5 again. The casing 40 comprises a sliding groove 401, a casing sidewall 403, a sliding groove sidewall 404, a first rib 405, a second rib 406, a post 407 and a scroll wheel seat 408. The sliding groove 401 is disposed at a lower portion of the casing 40. The sliding groove 401 is used for accommodating the sliding member 42 and the connector 44. The sliding groove 401 has a first perforation 4011 and a second perforation 4012 (see FIG. 8). The first perforation 4011 is arranged at an end of the casing 40. The second perforation 4012 is arranged at a bottom surface 402 (see FIG. 8) of the casing 40. The casing sidewall 403 is arranged at a side of the casing 40. The sliding groove sidewall 404 is arranged at a side of the sliding groove 401 and adjacent to the casing sidewall 403. The magnetic element 45 is arranged between the casing sidewall 403 and the sliding groove sidewall 404 for providing a magnetic force. In this embodiment, the magnetic element 45 is sheet-like, so that the magnetic element 45 can be arranged between the casing sidewall 403 and the sliding groove sidewall 404. The first rib 405 is disposed on the sliding groove sidewall 404 and adjacent to the first perforation 4011 of the sliding groove 401. The second rib 406 is disposed on the sliding groove sidewall 404 and arranged at a side of the first rib 405. The scroll wheel seat 408 is disposed on the lower portion of the casing 40. The scroll wheel 48 is installed on the scroll wheel seat 408.

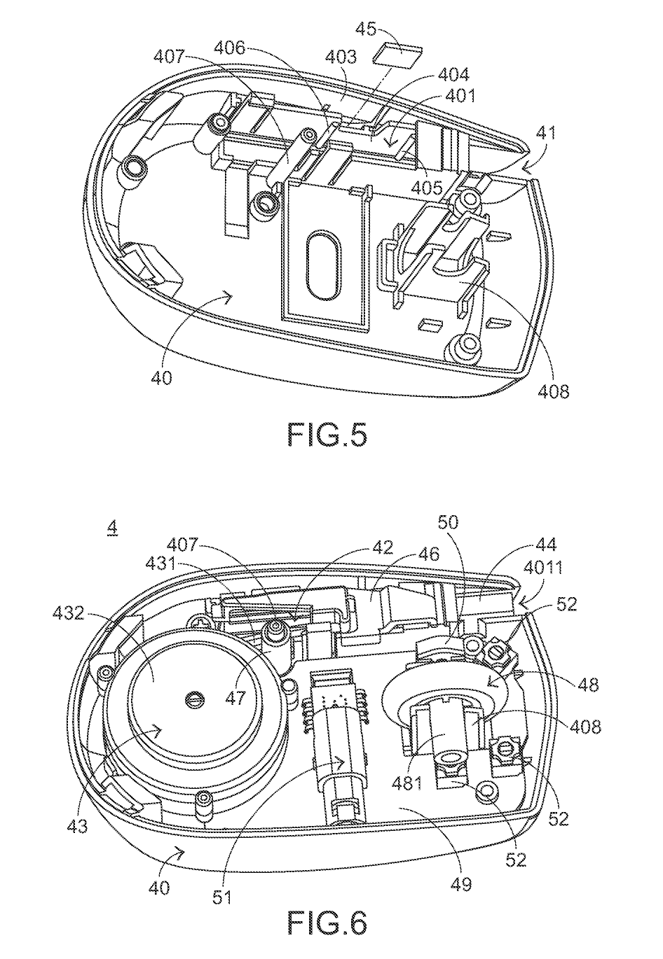

FIG. 6 is a schematic perspective view illustrating the internal portion of the retractable cable mouse according to the embodiment of the present invention. Please refer to FIGS. 5 and 6. The scroll wheel 48 is disposed on the lower portion of the casing 40. In addition, the scroll wheel 48 has a scroll wheel shaft 481. A scroll wheel shaft 481 is penetrated through the scroll wheel 48. The circuit board 49 is also disposed on the lower portion of the casing 40. The encoder 50 is disposed on the circuit board 49 and arranged at a side of the scroll wheel 48. A first terminal of the scroll wheel shaft 481 is inserted into the encoder 50. In response to rotation of the scroll wheel 48, the encoder 50 generates a scrolling signal. The displacement sensing element 51 is disposed on the circuit board 49 for detecting movement of the casing 40. In response to movement of the casing 40, the displacement sensing element 51 generates a motion signal. The triggering switches 52 are disposed on the circuit board 49. When the triggering switches 52 are triggered, corresponding signals are generated. For example, in a case that the triggering switch 52 is triggered by a second terminal of the scroll wheel shaft 481, a wheel pressing signal is generated. Whereas, in a case that a corresponding triggering switch 52 is triggered by a first button part or a second part of the upper cover 41, a first button signal or a second button signal is generated.

The cable reel member 43 is disposed within the casing 40 and on the circuit board. In addition, the cable reel member 43 is arranged at a side of the displacement sensing element 51. The cable reel member 43 comprises a connecting cable 431 and a reel main body 432. The connecting cable 431 is penetrated through the sliding member 42 and connected with the connector 44. The reel main body 432 is used for storing the connecting cable 431. In this embodiment, the connector 44 is a universal series bus (USB) connector. The post 407 is arranged between the sliding groove 401 and the cable reel member 43. The auxiliary roller 47 is sheathed around the post 407, so that the auxiliary roller 47 is fixed on the casing 40. Moreover, the auxiliary roller 47 is in contact with the connecting cable 431 of the cable reel member 43 40. In such way, during the process of pulling out or storing the connecting cable 431, the connecting cable 431 is not contacted with by the casing 40 or other components and thus the possibility of abrading the connecting cable 431 is minimized. The pressing member 46 is disposed over the sliding groove 401 to stop the connecting cable 431 from being escaped from the sliding member 42 (see FIG. 6).

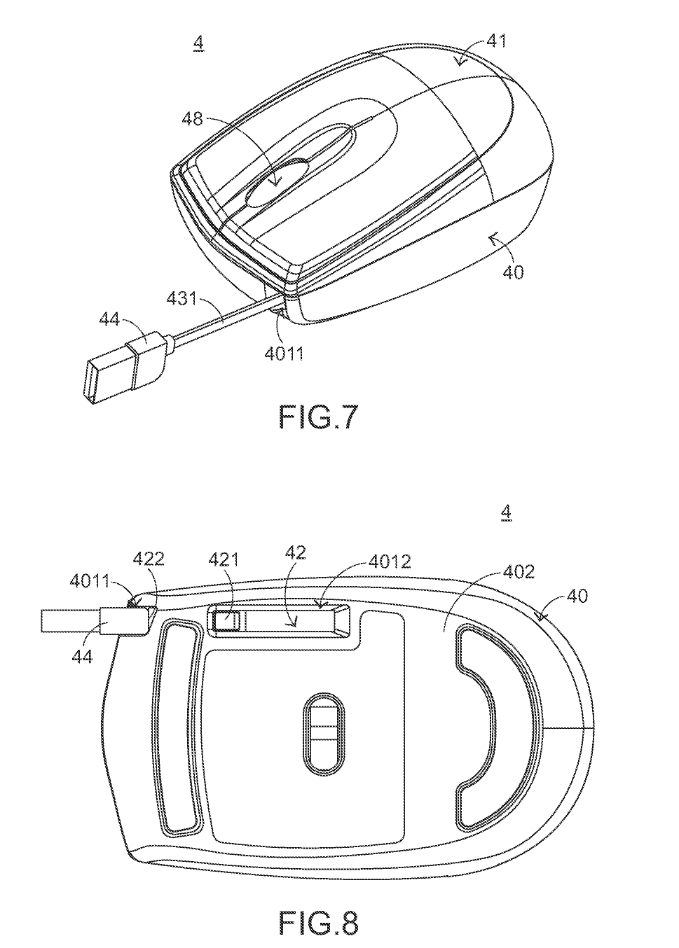

FIG. 7 is a schematic assembled view illustrating the outward appearance of the retractable cable mouse according to the embodiment of the present invention. After the retractable cable mouse 4 is assembled, the outward appearance thereof is shown in FIG. 7. The scroll wheel 48 is partially penetrated the upper cover opening 411 and exposed outside the upper casing 41 to be manipulated by the user.

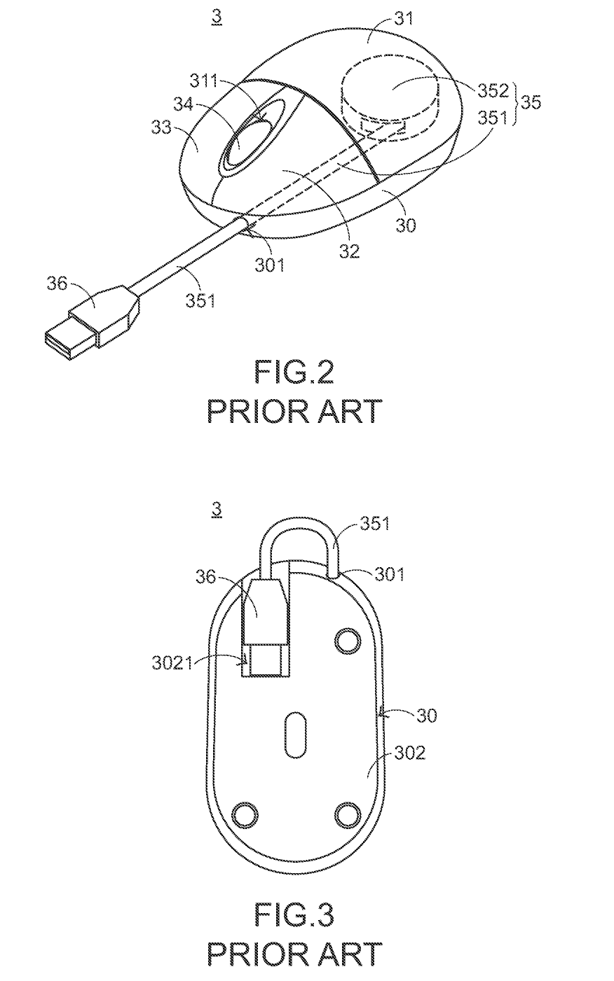

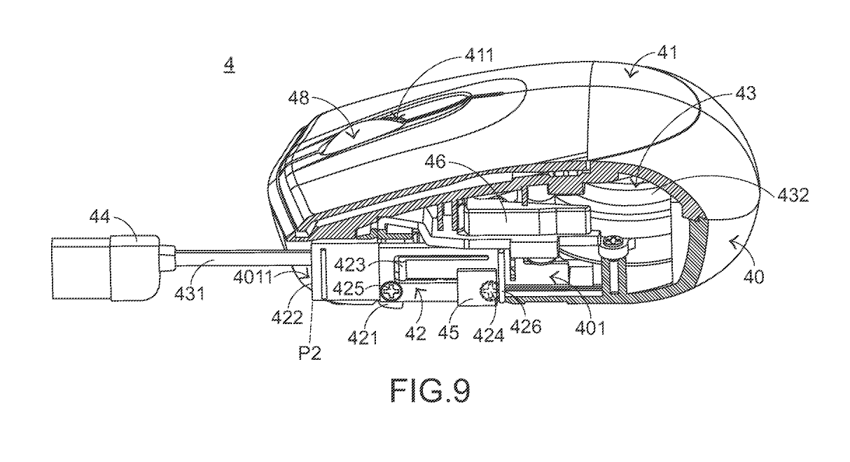

Hereinafter, a process of pulling out the connector 44 of the retractable cable mouse 4 will be illustrated with reference to FIGS. 8 and 9. FIG. 8 is a schematic rear view of the retractable cable mouse according to the embodiment of the present invention, wherein the connector is pulled out. FIG. 9 is a schematic cutaway view of the retractable cable mouse according to the embodiment of the present invention, wherein the connector is pulled out. For using the retractable cable mouse 4, the user may move the operating part 421 of the sliding member 42 to a second end of the second perforation 4012 (i.e. the end near the first perforation 4011), so that the sliding member 42 is slid to a second position P2 of the sliding groove 401. Under this circumstance, the connecting cable 431 is pulled out from the reel main body 432 and then exposed outside the casing 40 through the first perforation 401. At the same time, the connector 44 coupled with the connecting cable 431 is pushed by the sliding member 42 to be escaped from the first perforation 4011. In this situation, the cable reel member 43 is in a releasing status, wherein the first perforation 4011 is blocked by the front end 422 of the sliding member 42. Meanwhile, since the protrusion part 423 of the sliding member 42 is contacted with the first rib 405, the sliding member 42 is fixed at the second position P2 of the sliding groove 401. On the other hand, when the sliding member 42 is moved the second position P2 of the sliding groove 401, the first metal part 424 at the rear end 426 of the sliding member 42 is close to the magnetic element 45. Under this circumstance, the first metal part 424 is magnetically attracted by the magnetic element 45, and thus the sliding member 42 can be securely fixed at the second position P2 of the sliding groove 401. After the connector 44 of casing 40 is escaped from the first perforation 4011, the connector 44 can be pulled out and thus connected with the connecting port 211 of the computer host 21 (see FIG. 2). Under this circumstance, the communication between the retractable cable mouse 4 and the computer host 21, so that the movement of the cursor can be controlled by operating the retractable cable mouse 4.

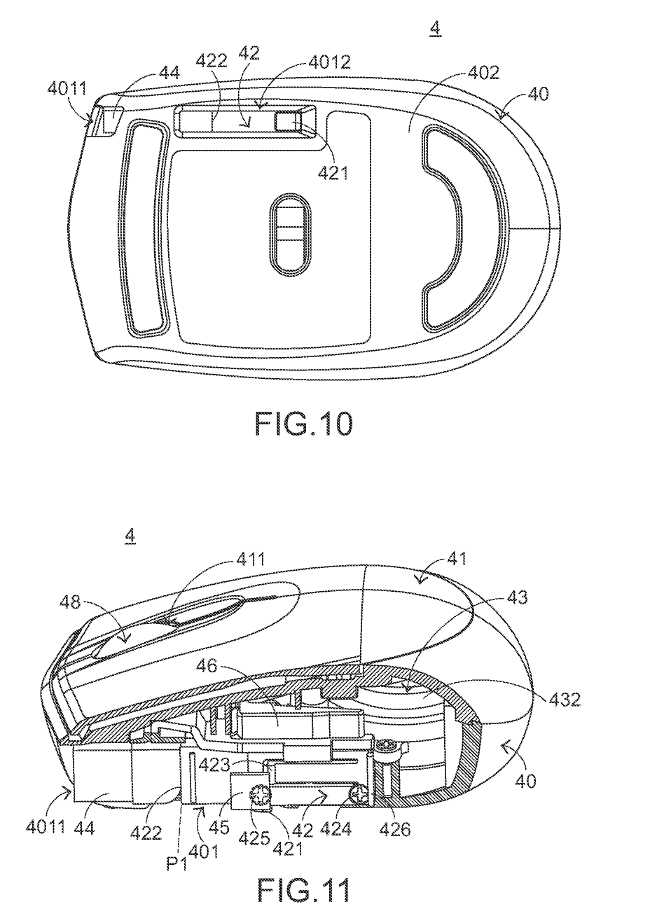

Hereinafter, a process of storing the connector 44 of the retractable cable mouse 4 will be illustrated with reference to FIGS. 10 and 11. FIG. 10 is a schematic rear view of the retractable cable mouse according to the embodiment of the present invention, wherein the connector is stored. FIG. 11 is a schematic cutaway view of the retractable cable mouse according to the embodiment of the present invention, wherein the connector is stored. In a case that the retractable cable mouse 4 is in a non-usage status and the user wants to store the connector 44, the connecting cable 431 is externally pulled in a direction distant from the sliding groove 401, so that the cable reel member 43 is switched from the releasing status to a storing status. Meanwhile, in response to a pulling force generated by the reel main body 432, the connecting cable 431 is retracted in the direction toward the reel main body 432 and stored within the reel main body 432. Consequently, the connector 44 is sustained against the sliding member 42, and the sliding member is moved to be received within the sliding groove 401.

Then, the user may move the operating part 421 of the sliding member 42 to a first end of the second perforation 4012 (i.e. the end distant from, the first perforation 4011), so that the sliding member 42 is slid to a first position P1 of the sliding groove 401. Under this circumstance, except for the portion of the connecting cable 431 within the sliding groove 401 and the portion of the connecting cable 431 beside the auxiliary roller 47, the majority of the connecting cable 431 is stored within the reel main body 432 and the connector 44 is received within the first perforation 4011 of the sliding groove 401. Meanwhile, since the protrusion part 423 of the sliding member 42 is contacted with the second rib 406, the sliding member 42 is fixed at the first position P1 of the sliding groove 401. On the other hand, when the sliding member 42 is moved the first position P1 of the sliding groove 401, the second metal part 425 at the middle region of the sliding member 42 is close to the magnetic element 45. Under this circumstance, the second metal part 425 is magnetically attracted by the magnetic element 45, and thus the sliding member 42 can be securely fixed at the first position P1 of the sliding groove 401.

From the above description, in a case that the retractable cable mouse 4 of the present invention is in the usage status, the user may pull out the connecting cable 431 to retrieve the connecting cable 431 back the reel main body 432. Moreover, when the operating part 421 exposed outside the bottom surface 402 of the casing 40 is moved by the user, the connector 44 may be stored within the sliding groove 401 in a sliding manner. For using the retractable cable mouse 4, the user may move the operating part 421 of the sliding member 42 to slide the sliding member 42, so that the sliding member 42 is sustained against the connector 44 to pull the connector 44 out of the casing 40. Meanwhile, since the first perforation 4011 of the sliding groove 401 is blocked by sliding member 42, the external dust or foreign material fails to be introduced into the internal portion of the casing 40.

As previously described, since the connector of the conventional retractable cable mouse is stored within the receiving recess of the bottom surface of the casing, the connector is exposed outside the casing and easily damaged. On the other hand, since the connector of the retractable cable mouse of the present invention can be completely stored within the casing, the connector can be effectively protected. Moreover, for storing the connector of the conventional retractable cable mouse, since it is necessary to bend the connecting cable of the cable reel member, the connecting cable is easily damaged. On the other hand, since the connector of the retractable cable mouse of the present invention can be completely stored within the casing without the need of bending the connecting cable, the efficacy of protecting the connecting cable is enhanced. Moreover, the use of the auxiliary roll in the retractable cable mouse of the present invention can further protect the connecting cable. By means of the auxiliary roll, during the process of pulling out or storing the connecting cable, the connecting cable is not contacted with by the casing or other components and thus the possibility of abrading the connecting cable is minimized. In other words, the retractable cable mouse of the present invention is easily carried and aesthetically pleasing, and has good efficacy of protecting the connecting cable and the connector.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A retractable cable mouse, comprising:
a casing having a sliding groove, which is disposed at a lower portion of said casing, wherein said sliding groove has a first perforation and a second perforation, wherein said first perforation is arranged at an end of said casing, and said second perforation is arranged at a bottom surface of said casing;
a cable reel member disposed within said casing;
a connector coupled with said cable reel member, and selectively accommodated within said sliding groove or protruded outside said sliding groove, wherein when said connector is protruded outside said sliding groove, said connector is permitted to be connected with a computer system; and
a sliding member disposed within said sliding groove and arranged adjacent to said connector, and having an operating part, wherein said operating part is protruded outside said second perforation and movable to allow said sliding member to be slid along said sliding groove, wherein when said operating part is moved to a first end of said second perforation, said sliding member is slid to a first position of said sliding groove, so that said connector is stored within said sliding groove, wherein when said operating part is moved to a second end of said second perforation, said sliding member is slid to a second position of said sliding groove to push said connector to allow said connector to be escaped from said sliding groove, and said first perforation is blocked by a front end of said sliding member, so that said able reel member is in a releasing status.

2. The retractable cable mouse according to claim 1 wherein said cable reel member comprises:
a connecting cable penetrated through said sliding member to be coupled with said connected; and
a reel main body for storing said connecting cable, wherein when said cable reel member is in said releasing status, said connecting cable is protruded out of said reel main body and exposed outside said casing, wherein when said cable reel member is in said storing status, said connecting cable is stored within said reel main body in response to a pulling force generated by said reel main body.

3. The retractable cable mouse according to claim 2 further comprising a pressing member, which is disposed over said sliding groove to stop said connecting cable from being escaped from said sliding member.

4. The retractable cable mouse according to claim 1 wherein said casing further comprises:
a casing sidewall arranged at a side of said casing;
a sliding groove sidewall arranged at a side of said sliding groove and adjacent to said casing sidewall;
a first rib disposed on said sliding groove sidewall and adjacent to said first perforation of said sliding groove; and
a second rib disposed on said sliding groove sidewall and arranged at a side of said first rib.

5. The retractable cable mouse according to claim 4 wherein said sliding member further comprises a protrusion part, which is disposed on a surface of said sliding member, wherein when said protrusion part is in contact with said first rib or said second rib, said sliding member is fixed on said first position or said second position of said sliding groove.

6. The retractable cable mouse according to claim 4 further comprising a magnetic element, wherein said magnetic element is arranged between said casing sidewall and said sliding groove sidewall for providing a magnetic force.

7. The retractable cable mouse according to claim 6 wherein said sliding member further comprises:
a first metal part disposed on a surface of said sliding member and arranged at a rear end of said sliding member, wherein when said first metal part is magnetically attracted by said magnetic element, said sliding member is fixed at a second position of said sliding groove; and
a second metal part disposed on said surface of said sliding member and arranged at a middle region of said sliding member, wherein when said second metal part is magnetically attracted by said magnetic element, said sliding member is fixed at a first position of said sliding groove.

8. The retractable cable mouse according to claim 1 further comprising an auxiliary roller, which is in contact with a connecting cable of said cable reel member for facilitating said connecting cable to be pulled out or stored, wherein said casing further comprises a post, which is arranged between said sliding groove and said cable reel member, wherein said auxiliary roller is sheathed around said post, so that said auxiliary roller is fixed on said casing.

9. The retractable cable mouse according to claim 1 further comprising:
an upper cover for sheltering said casing, wherein said upper cover has an upper cover opening;
a scroll wheel disposed on a scroll wheel seat of said casing and partially penetrated through said upper cover opening to be exposed outside said upper casing, wherein a scroll wheel shaft is penetrated through said scroll wheel;
a circuit board disposed on said lower portion of said casing;
an encoder disposed on said circuit board and arranged at a side of said scroll wheel, wherein an terminal of said scroll wheel shaft is inserted into said encoder, and said encoder generates a scrolling signal in response to rotation of said scroll wheel;
a displacement sensing element disposed on said circuit board for detecting movement of said casing, thereby generating a motion signal; and
plural triggering switches disposed on said circuit board, wherein when said triggering switches are triggered, corresponding signals are generated.

10. The retractable cable mouse according to claim 1 wherein said connector is a universal series bus (USB) connector.
